(19) United States
(12) Patent Application Publication
(10) Pub. No.: US 2008/0288280 A1
(43) Pub. Date: Nov. 20, 2008

(54) SYSTEM AND METHOD FOR MEETING PAYER PROTOCOLS

(76) Inventors: Deborah J. Belcher, Hinesburg, VT (US); Mary J. Ammer, Roseville, MN (US); William Estel Cheetham, Clifton Park, NY (US); Rajesh Venkat Subbu, Clifton Park, NY (US); Feng Xue, Clifton Park, NY (US); Bernhard Joseph Scholz, Ballston Lake, NY (US); Piero Patrone Bonissone, Schenectady, NY (US)

Correspondence Address: ANDRUS, SCEALES, STARKE & SAWALL, LLP, 100 EAST WISCONSIN AVENUE, SUITE 1100, MILWAUKEE, WI, 53202, US

(21) Appl. No.: 11/748,611

(22) Filed: May 15, 2007

(51) Int. Cl. G06Q 10/00; G06F 17/18

(52) U.S. Cl. 705/2; 707/104.1

(57) ABSTRACT

A system and method for processing healthcare service data is herein disclosed. The system comprising a decision engine in communication with a process manager and a knowledge source. The decision engine receives at least one protocol from the knowledge source that is derived by automated learning and applies the at least one protocol to healthcare service data and transmits a response to the process manager such that the response is indicative of a next workflow step to be taken.

### FIELD OF THE DISCLOSURE

The present disclosure generally relates to the field of healthcare administration. In particular, the present disclosure is directed to an improved system and method for meeting healthcare service data requirements.

### BACKGROUND

The healthcare industry consists of a wide network of interrelated systems that use a number of complex processes for preparing and exchanging healthcare service data. This network consists of physicians, hospitals, clinics, laboratories, insurance plans, government health programs and other ancillary services and plans. These individual components further include individual departments specialized in managing a particular subset of healthcare service data. The healthcare service data may include patient electronic medical records (EMRs), payer information, procedure information, or any other data related to the healthcare industry. This data often resides in any number of forms and in any number of locations. Thus, a particular exchange between two parties may become a complicated and inefficient process resulting in a substantial waste of resources, time, and money.

The preparation and adjudication of healthcare claims are examples of the complex processing of healthcare service data that must be achieved. These often slow-moving procedures involve at least two parties, the payers, i.e. health plans, insurance plans or a government health program, and the care delivery organization (CDOs), i.e. hospitals, physicians or healthcare providers. Unfortunately, these parties conduct business in a manner that is frequently adverse. The relationship between the payers and the CDOs involves the provision of services by the CDOs, a request by the CDOs to the payer in the form of an authorization or a claim for payment for the services, and the adjudication and payment of the claims by the payer.

The adversarial nature of this relationship is exacerbated by inefficiencies in the processing and transaction of the healthcare service data. In a paper-based system, the healthcare service data must be manually assembled to comprise the information and content data required by the payer to complete the transaction. The payer reviews the healthcare service data and if the required information and content data is not present or is incomplete, the payer may send a request for additional information back to the CDO. The CDO must fulfill the request by locating, assembling, and forwarding the requested data back to the payer. The payer continues authorization or adjudication, and may repeat this procedure several times for a single transaction until all required information has been received. As a result, CDOs may initially file healthcare service data, or respond to requests for additional information with large amounts of unnecessary data in an effort to preempt any additional requests from the payer. Other payers may not send a request for additional information, but instead deny payment for the claim. The CDO must then locate, gather, and assemble the additional data and resend it to the payer as a resubmitted or appealed claim.

The Health Insurance Portability and Accountability Act (HIPAA) of 1996 sought to streamline the process by establishing electronic data interchange standards for the electronic conveyance of healthcare data. HIPPA aims to make the process of submitting and adjudicating healthcare claims more efficient by providing a structured set of standardized electronic data for many forms of healthcare data transactions. The structured data lowers the administrative overhead by reducing the pervasive need for human intervention in preparing and processing healthcare data transactions. These changes also improve turnaround time and provide a level of predictability to the healthcare data transaction process.

In the example of a healthcare claim adjudication transaction, HIPAA mandates the use of standard ASC X12N formats for the exchange of data between the payers and CDOs. The CDOs submit a healthcare claim using an X12N 837 standard electronic claim (837 claim) transaction. The payer will review this claim and if additional documentation is required, the payer may request additional information using an X12N 277 request for additional information (277 request) transaction. The CDOs receive this transaction and may respond by transmitting an X12N 275 additional information in support of the healthcare claim or encounter (275 additional information) transaction to the payer.

In the example of healthcare service pre-authorization or pre-certification transactions, HIPAA mandates the use of standard ASC X12N 278 transactions for the exchange of data between the payers and CDOs. The CDOs submit a request for healthcare service review using an X12N 278 standard electronic request (278 request) transaction. The payer will review this request and if additional documentation is required, the payer may request additional information in support of the request by using an X12N 278 response for additional information (278 response) transaction. The CDOs receive this 278 response transaction and may respond by transmitting an X12N 275 additional information to support a healthcare service review transaction to the payer.

The 275 additional information contains the requested additional information in HL7 clinical document architecture (CDA) format defined by the Health Level Seven (HL7) standards organization. The CDA format is wrapped in an X12 275 additional information format for transmission. The CDA format allows the exchange of a healthcare data transaction through electronic data interchange networks and software tools by specifying the document structure. The content includes logical observation identifier names and codes (LOINC), a universal coding system for identifying and reporting clinical and laboratory observations or document types in HL7 electronic messages. The CDA standard accommodates either manual or automatic processing of healthcare data transactions. The manual processing method, or “human decision-making variant,” allows scanned images, or free-form text, or structured data to be electronically sent in the 275 additional information and to be reviewed by a person processing the transaction. In contrast, the automatic processing method, or “computer decision-making variant” contains additional structured information that allows computer-based decision algorithms to extract the content data.

A healthcare service data transaction system may be made more efficient by implementing a system that reviews the healthcare service data and provides a determination of whether the healthcare service data meets predetermined requirements for healthcare service data contents or for additional information required for a particular transaction. Systems have been developed that attempt to create a database of rules that mimic these requirements. In response to a newly developed requirement, a technician develops a rule and stores it in the rule database. The rules may individually define the proper form, contents, or attachments needed for a particular transaction of healthcare service data. The submitted healthcare data is processed by applying some or all of the rules to determine what, if any, additional information is needed.

However, these systems are limited by the inherent structure of a rule based system. First, payer requirements must be discovered and then rules must be developed and implemented by one skilled in the art of rule development and who is knowledgeable in the requirements for each payer to reflect any changes in the healthcare service data requirements. This requires constant manual intervention and updating of the system that quickly becomes expensive and both temporally and monetarily inefficient to maintain. Next, a rule-based system is not economically scalable. Specific requirements may be required for each payer and CDO in a healthcare network. Furthermore, Federal Law, State Law, and other Regulatory Agencies may each require different additional requirements. A national or regional payer or CDO may have to maintain rules for use with each different payer or CDO and maintain rules for use in each geographical region in which the payer or CDO operates due to differences in governmentally mandated protocols. The required rules that must be developed and maintained quickly grows to an over burdensome system. Additionally, logical rules suffer from the inherent limitation that a particular requirement may not always be able to be reflected as an accurate logical statement.

Therefore a system and method is desirable that can process healthcare service data to determine whether the healthcare service data meets transaction requirements for that healthcare service data. Additionally, it is desirable for a system and method that provides an indication of any additionally required content or healthcare service data to meet the requirements for the transaction. Furthermore, it is desirable that the system and method be automatically updated and modified in response to a requirement change. While such a system would be desirable for improving the preparation and adjudication of healthcare claims, this system could be applied to many other transactions of healthcare service data in the healthcare field.

### BRIEF DISCLOSURE

A method of processing healthcare service data is herein disclosed. The method determines if healthcare service data requires additional content data. The method comprises receiving the healthcare service data and receiving at least one protocol from at least one knowledge source comprising at least one protocol derived by automated learning. Next, the at least one protocol is applied to the healthcare service data to determine if additional content data is required to meet the at least one protocol. Upon determining that additional content data is required, a response is generated. The response is indicative of the content data required to meet the at least one protocol.

Additionally, a decision engine is utilized in conjunction with an automated system for processing healthcare service. The decision engine comprises a knowledge source in communication with at least one database of healthcare service data. The knowledge source identifies at least one protocol derived by automated learning from the healthcare service data. The decision engine further comprises a means for applying at least one protocol that is in communication with the knowledge source and is in communication with the process manager such that healthcare service data is transferred from the process manager. The system applies at least one protocol from the knowledge source to the healthcare service data to determine the required content data. Then the system transmits a response indicative of the required content data to the process manager.

Furthermore, a healthcare workflow system for processing healthcare service data to identify required content data to be sent to a payer is herein disclosed. The system comprises an input device facilitating the entry of healthcare service data and a process manager in communication with the input device to receive the healthcare service data. A knowledge source is in communication with at least one database of historical healthcare service data and identifies at least one protocol by automated learning from the historical healthcare service data. A decision engine is in communication with the process manager and the knowledge source. The decision engine receives the healthcare service data from the process manager and receives at least one protocol from the knowledge source. Then the decision engine applies the at least one protocol to the healthcare service data to produce a response indicative of required content data and transmits the response to the process manager. If content data is required, the system may further comprise at least one output device in communication with the process manager such that an output device receives the response from the process manager and may present an indication of a workflow step to be performed in accordance with the response.

### BRIEF DESCRIPTION OF THE DRAWINGS

FIG. 1 depicts a schematic diagram of a healthcare information network;

FIG. 2 depicts a simplified schematic of a decision engine;

FIG. 3 depicts a more detailed embodiment of a decision engine;

FIG. 4 depicts an alternative embodiment of a decision engine;

FIG. 5 depicts a flow chart depicting an embodiment of a method of processing healthcare service data;

FIG. 6 depicts an embodiment of a method of processing healthcare service data using case-based reasoning; and

FIG. 7 depicts an alternative offline embodiment of a method of processing healthcare service data using case-based reasoning.

### DETAILED DISCLOSURE

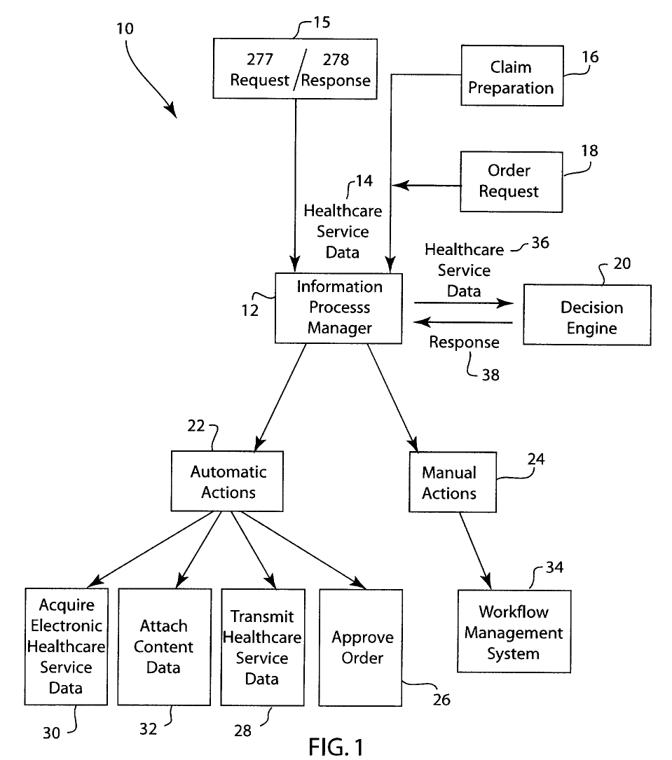

FIG. 1 depicts a schematic diagram of a healthcare information network 10. The healthcare information network 10 comprises an information process manager 12 that receives healthcare service data 14 from a variety of sources and processes the healthcare service data 14 to identify a next action to be taken in the handling of the healthcare service data transaction. The healthcare service data 14 received by the information process manager 12 may come from a variety of sources. These sources may represent input devices for different types of healthcare service data to be processed by the information process manager 12. The input devices may comprise a computer terminal for the manual entry of data, an automated system performing an action or a network communications connection for receiving electronic data. The forms of the healthcare service data 14 from these sources may include X12N 277 request (277 request) or X12N 278 response (278 response) 15 that is received from an external source, which may be a healthcare service payer. The 277 request or 278 response 15 may include an identification of healthcare service or content data that is required for the adjudication of the healthcare service claim or the approval of the healthcare service request by the payer. In one contemplated embodiment, required healthcare service data may include electronic data to be pulled from the patient's EMR and/or content data that may include an electronic copy of a particular document or record. In response to a 277 request or a 278 response 15, the item supported by the system may be the preparation of a X12N 275 additional information (275 additional information) with additional healthcare service and content data.

Additionally, the healthcare service data 14 may be received by the information process manager 12 as a claim preparation 16. Healthcare service data 14 received as part of a claim preparation 16 may be submitted to the information process manager 12 by a clinician or other CDO employee to begin the process of preparing a new claim be submitted to a payer to receive remittance for healthcare services performed. The clinician or employee may enter healthcare service data identifying the patient, the procedure, the location where the procedure was performed, any clinicians involved in the performance of the procedure, or patient insurance coverage data. However, this list is in no way intended to be limiting on the scope of the healthcare service data that may be entered by a clinician or employee initiating a claim preparation 16. The process manager 12 processes the healthcare service data 14 received from the claim preparation 16 to facilitate the X12N 837 claim transaction (837 claim).

Additionally, the information process manager 12 may receive healthcare service data 14 as an order request 18. The order request 18 may be sent to the information process manager 12 by a clinician to check on the need for pre-approval of payer coverage or CDO approval of a medical procedure to be performed on a patient in the future. The clinician may schedule a tentative date for the procedure and simultaneously generate an order request 18 such that the information process manager 12 may assist in facilitating a decision on the coverage or other approval for performing the medical procedure on the patient. Therefore, the patient may be notified in advance as to the coverage status of the procedure, and the date for performing the procedure will not be unnecessarily delayed by waiting for these approvals.

The healthcare service data 14, whether the source is a 277 request or 278 response 15, a claim generation 16, an order request 18, or an alternative source, may be input by a clinician, other CDO employees, or third parties using an input device (not depicted) connected to an information network, such as a LAN, a WAN, or the internet, that places the input device in communication with the information process manager 12. The input device need not be located proximally to the information process manager 12; rather, any input device connected to an information network such that healthcare service data 14 may be transmitted between the input device and the information process manager 12 may be used.

Once the information process manager 12 has received the healthcare service data 14, the information process manager 12 requires an indication of what steps are to be taken to properly process the healthcare service data 14. These steps reflect any requirements that are to be followed for processing the received healthcare service data. The requirements may come from any of a variety of sources that include, but are not limited to, government or regulatory requirements, payer requirements, and CDO requirements. The process manager 12 sends healthcare service data 36 to a decision engine 20 that determines if the healthcare service data 36 is in compliance with the proper requirements. Healthcare service data 36 may be a subset of healthcare service data 14 received by the process manager 12. Healthcare service data 36 may comprise some or all of healthcare service data 14 and may include only that information that is deemed necessary for determining compliance and next step requirements. The decision engine 20 utilizes the healthcare service data 36 transmitted to the decision engine 20 to identify protocols that represent one or more requirements for processing the healthcare service data 14. The decision engine 20 may also identify protocols that apply to the particular type of transaction to be performed based on the healthcare service data 14 received by the information process manager 12. The decision engine 20 applies the identified protocols to the healthcare service data 36 and provides a response 38 back to the process manager 12. The response 38 is indicative of the next action to be taken in processing the healthcare service data.

Upon receiving the response 38, the process manager 12 determines the next action that must be taken with respect to moving the healthcare service data transaction towards an adjudication or an approval. Some of the actions that may be performed may comprise automatic actions 22 where a computer, a computer system, or a network system automatically performs a healthcare service data processing task, without the need for intervention by a human clinician or other employee. Non-limiting examples of automatic actions 22 that may be taken include the automated next step in the order process for medical procedures 26, transmitting a completed healthcare service claim 28, which may be in the form of an 837 claim, a 275 additional information, or a 278 request transaction acquiring additional needed electronic healthcare service data 28, which may be identified by one or more LOINC codes, or attaching content data 30 that is needed to fulfill an applied protocol.

Manual actions 24 identified by the information process manager 12 may include the same actions identified in relation to the automatic actions 22 but for one reason or another the CDO is unable to perform the action automatically and therefore the action must be placed in a workflow management system 34 so that a clinician or other employee may perform the action. Additionally, other manual actions 24 placed in the workflow management system 34 may include actions such as the manual review of the response outcome of the decision engine by a specific person.

While the healthcare information network 10 is depicted as a series of blocks or modules, it is understood and within the scope of the present disclosure that the blocks or modules are designated based on their functionality and may be physically implemented independently or in combination with other blocks or modules. As such, the healthcare network 10 may be implemented across a network comprising a number of computers or servers, or alternatively the entire network 10 may be implemented on a single computer or processor. Furthermore, the blocks or modules as designated in FIG. 1 may be implemented as computer programs or coded modules of one or more computer programs.

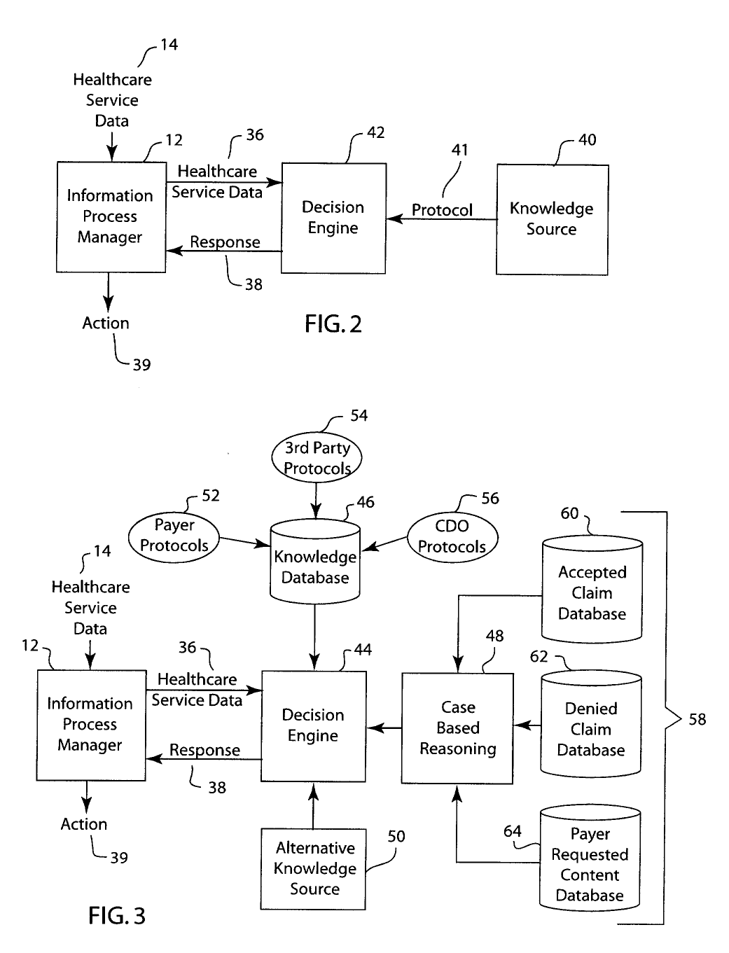

FIG. 2 depicts a system diagram of an embodiment of the decision engine 20. The decision engine 42 is communicatively connected to the information process manager 12 such that data may be transferred between the decision engine 20 and the information process manager 12. In the embodiment shown, the information process manager 12 receives healthcare service data 14 and transmits some or all of the received healthcare service data 36 to the decision engine 42. The decision engine 42 processes the healthcare service data 36 and returns a response 38 to the information process manager 12. The response 38 may include an identification of the next action 39 to be taken in processing the healthcare service data. Alternatively, the process manager 12 may determine the next action 36 to be taken based upon the response 38 received from the decision engine 42.

The decision engine 42 is further communicatively connected to a knowledge source 40. The knowledge source 40 comprises a plurality of protocols that determine format, service, or content data requirements for processing healthcare service data. The knowledge source 40 may comprise at least one of a wide variety of knowledge sources that define healthcare service data processing protocols. The protocols may be identified in a variety of manners as to be further described herein. The knowledge source 40 may further comprise a plurality of knowledge sources; however a plurality is not required. At least one knowledge source 40 that is communicatively connected to the decision engine 42 comprises at least one protocol that is derived by an automated learning process analyzing historical healthcare service data.

The decision engine 42 processes the healthcare service data 36 to identify one or more protocols that define the requirements for processing the healthcare service data. The decision engine 42 then retrieves the protocols from the knowledge source 40 and applies the one or more protocols to the healthcare service data 36 to produce a response 38 that is indicative of the next step to be taken in processing the healthcare service data. The response 38 may include an indication of any additional healthcare service or content data that must be added to the healthcare service data 14. The response 38 may alternatively indicate a next processing step to be taken by the system or manual review of the healthcare service data. The decision engine 42 may be implemented in a variety of ways to identify the protocols, retrieve the protocols, apply the protocols, produce a response, and transmit a response. The decision engine 42 may therefore comprise either or both of electronic hardware or computer programmed solutions to achieve this functionality. In a computer programmed implemented decision engine, the program may be broken into modules and performed on one or more processors or computer systems, or may be entirely implemented by a single processor as part of a larger program.

FIG. 3 depicts a more detailed schematic diagram of a contemplated embodiment of the decision engine 20 (depicted in FIG. 1). FIG. 3 depicts a fusion decision engine 44. The fusion decision engine 44 is similarly connected to the information process manager 12 as depicted in FIGS. 1 and 2 and as such receives the healthcare service data 36 from the information process manager 12 and transmits the response 38 back to the information process manager 12. The fusion decision engine 44 is connected to a plurality of knowledge sources. The knowledge sources may comprise one or more of: a knowledge database 46, a case-based reasoning module 48, or an alternative knowledge source 50. The decision engine 44 may pull protocols from each of the knowledge database 46, case-based reasoning module 48, or the alternative knowledge source 50. The decision engine 44 may use this variety of protocols in providing an accurate response 38 as to the proper action to be taken in processing the healthcare service data.

The knowledge database 46 may comprise a database of protocols that have been defined by a variety of sources. The protocols in the knowledge database 46 may include payer identified protocols 52, third party protocols 54 and/or CDO defined protocols 56. The payers may define protocols and transmit them to each of the CDOs to be stored in the knowledge database 46 such that the payer protocols 52 may be implemented to improve the process of the system described herein. Other payers may define protocols but may rather choose to publish the protocols on an internet website or on paper. The CDOs may then be responsible for the collection and implementation of these protocols in the knowledge database 46. Alternatively, the CDOs themselves may define CDO protocols 56 that define processes or actions to be taken with specified healthcare service data transaction in relation to the business organization of the CDO, or other institutional concerns of the CDO. The knowledge database 46 may comprise separate databases for each of the different types of protocols; however, this is not necessary and the protocols may be all stored in a single database within the scope of this disclosure.

The fusion decision engine 44 may further receive protocols from a case-based reasoning module 48. The case-based reasoning module 48 may implement mathematical analysis of historical data to define a protocol based upon an analysis of the healthcare service data 36 that is transmitted to the decision engine 44. The case-based reasoning module 48 may have access to a variety of databases 58 of historical healthcare service data. The data in the historical healthcare service databases 58 may comprise stored historical healthcare service data, created healthcare service data to represent specific occurrences, or contemporaneously recorded healthcare service data.

In the embodiment depicted in FIG. 3 the healthcare service transactions of generating an 837 claim or an 275 additional information are herein exemplarily used. The historical healthcare service data databases 58 may comprise an accepted claim database 60. The accepted claim database 60 may comprise data identifying claims transmitted to each payer to which the CDO transmits claims as well as data identifying the procedures for which the claim was sent and the healthcare service data transmitted along with the claim. The accepted claim database 60 may comprise only those claims that were accepted and/or paid by the payer. Therefore, the case-based reasoning module 48 may use the historical healthcare service data in the accepted claim database 60 to determine healthcare service data or combinations of healthcare service data required by each payer in order to accept a claim.

The historical healthcare service data databases 58 may further comprise a denied claim database 62 that may comprise healthcare service data identifying the payer, the procedure involved, and the healthcare service data that was transmitted to the payer along with the claim for those claims that resulted in a denial by the payer. Therefore, the case-based reasoning module 48 may utilize the data in the denied claim database 62 to identify protocols defining those instances of healthcare service data and/or combinations of healthcare service data that are likely to result in a denied claim for payment of services.

Furthermore, the historical healthcare service data databases 58 may comprise a payer requested content database 64. The payer requested content database 64 may comprise data that is indicative of the claims transmitted to a payer by a CDO was well as the healthcare service data transmitted along with those claims that resulted in the payer responding with a 277 request or a 278 response. The payer requested content database 64 may also comprise the types of additional content, including documents, that were requested in the 277 request or the 278 response. Therefore, the case-based reasoning module 48 may utilize the data in the payer requested content database 64 to identify combinations of healthcare service data that may result in a payer rejecting a claim or denying authorization for a lack of necessary information, as well as the healthcare service data that is likely to be requested by the payer in order to process the claim.

The case-based reasoning module 48 may utilize the data in any of the historical healthcare service databases 58 to identify one or more protocols that may be applied to the healthcare service data 36 transmitted to the decision engine 44 to properly analyze the requirements for the current transaction. In this respect, the case-based reasoning module 48 utilizes the healthcare service data 36 to create a new protocol based upon learning from the historical healthcare data databases 58. The historical healthcare service data databases 58 may be continuously updated as healthcare service data is processed according to the presently disclosed system and method. Therefore, the case-based reasoning module 48 is responsive to any changes in healthcare service data requirements initiated by a payer, without the need for an indication of such requirement changes from the payer to the CDO. The case-based reasoning module 48 compliments the knowledge database 46 as payers that define payer protocols 52 and regularly update the payer protocols 52 may have the proper protocols stored in the knowledge database 46 for use by the decision engine 44, while payers that do not create payer protocols 52 will have protocols created for them, based on previous similar transactions, by the case-based reasoning module 48 such that the decision engine 44 may be used in processing healthcare service data transactions for payers or applications that do not create their own predefined protocols.

While a case-based reasoning module 48 has been described in detail herein, the fusion based decision engine 44 may utilize protocols that are retrieved through any number of alternative knowledge sources 50 that may or may not comprise a case-based reasoning module 48. These alternative knowledge sources 50 may comprise other types of automated processing or automated processing of historical healthcare service data. The alternative knowledge source 50 may comprise, but is not herein limited to, a decision tree, a random forest, a neural-network, or a look-up table. However, alternative methods of processing a set of data to define a protocol may be implemented within the scope of the present disclosure. In each of these instances, the alternative knowledge source 50 comprises a method or module that analyzes historical healthcare service data to define a protocol that may then be used by the decision engine 44 in processing the healthcare service data 36.

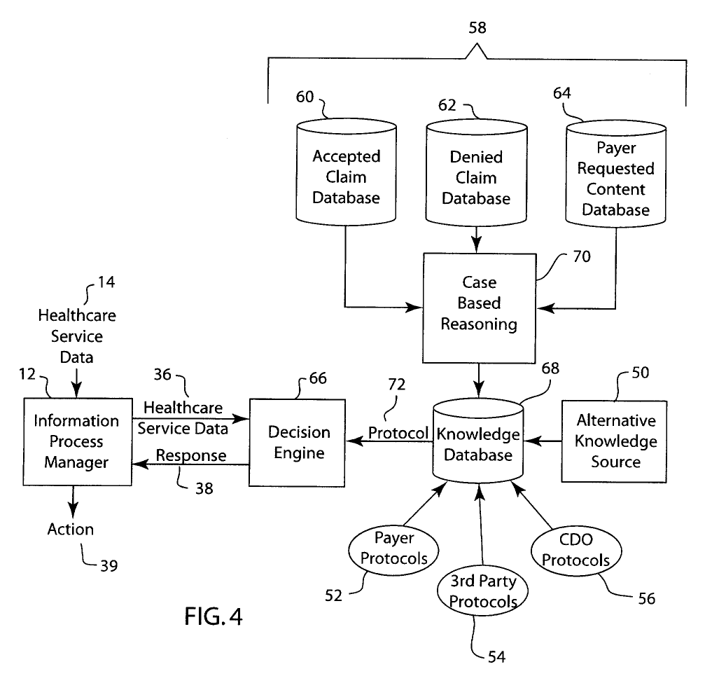

FIG. 4 depicts a schematic diagram of an alternative embodiment of a decision engine implementation. The information process manager 12 receives healthcare service data 14 and transmits healthcare service data 36, which is a subset of the healthcare service data 14, to the decision engine 66. The decision engine 66 is connected to at least one knowledge database 68 wherein a plurality of protocols from a variety of sources is stored. The knowledge database 68 may comprise a single database, or may be a plurality of databases that are used in conjunction to store all of the protocols. The knowledge database 68 may comprise payer defined protocols 52, third party defined protocols 54, or CDO defined protocols 56. These protocols may be manually entered upon the definition of a new protocol by one of the aforementioned protocol sources, or another source of protocols. Alternatively, these protocols may be automatically updated within the knowledge database 68 as the knowledge database 68 is connected to an information network (not depicted) from which the new or modified protocols may be obtained.

Alternatively, the knowledge database 68 may receive protocols from a case-based reasoning system 48. The case-based reasoning system 48 may comprise an on-line case-based reasoning system or an off-line case-based reasoning system, or a hybrid implementation that utilizes both. The case-based reasoning system 48 may rely upon a plurality of historical healthcare service data databases 58. The historical healthcare service data databases 58 may comprise a database of accepted claims 60, a database of denied claims 62, or a database of payer requests 64. The case-based reasoning system 70 processes the data in the historical healthcare service data databases 58 to identify new protocols that may be defined, or modifications that may be made to existing protocols to more accurately reflect the process and information requirements of the payers. The case-based reasoning module 70 may then transmit the newly defined protocols or the updated versions of existing protocols to the knowledge database 68 wherein the protocols are stored.

Alternatively, protocols may be defined by alternative knowledge sources 50 that may include a decision tree, a random forest, a neural network, or a look up table; however, alternatively methods of processing healthcare service data may be similarly used to define protocols within the scope of the disclosure. The protocols defined by the alternative knowledge sources 50 are also sent to the knowledge database 68 to be stored for retrieval.

The decision engine 66, upon receiving the healthcare service data 36 searches the knowledge database 68 to identify and procure protocols 72 that may be used by the decision engine 66 for processing the healthcare service data 36. After the decision engine 66 has applied one or more protocols 72 to the healthcare service data 36, the decision engine 66 returns a response 38 to the information process manager 12. The response 38 is indicative of the next action or workflow step that is to be taken, such that an indication of the next action or workflow step may be made.

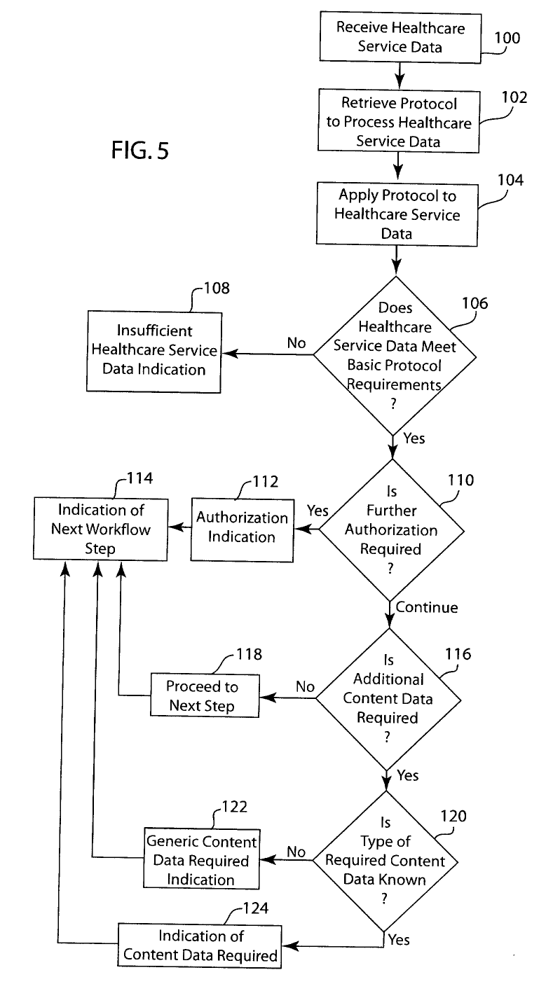

FIG. 5 depicts a flow chart of the steps of an embodiment of a method of processing healthcare service data as will be disclosed herein. First, healthcare service data is received at step 100. The healthcare service data may comprise any of the types of healthcare service data previously described herein. The healthcare service data generally comprises at least an identification of the provider, the services at issue, and the associated payer; however these may not be necessary in all embodiments for processing healthcare service data. Next, based on the received healthcare service data, at least one protocol is retrieved at step 102. The at least one protocol is selected based upon the received healthcare service data, which is preliminarily used to help to determine the proper at least one protocol to be used to process the healthcare service data transaction.

Next, in step 104, the at least one protocol is applied to the healthcare service data to analyze the healthcare service data to determine the next step required in processing the healthcare service data. In applying the at least one protocol to the healthcare service data, first one or more protocols are applied to the healthcare service data to determine if the healthcare service data meets basic protocols in step 106. These basic protocols may include verifying that the healthcare service data includes required data elements, such as the identification of the provider and the services at issue. The basic protocols may comprise a proper identification of a payer to receive any claim or request for authorization of based upon the services rendered to the patient. Furthermore, the basic protocols may comprise verification that specific data required by the CDO, the payer, or a third party be present such that the transaction may be properly processed. If the healthcare service data does not meet the basic protocols, an indication of insufficient healthcare service data may be made at step 108.

The indication of insufficient healthcare service data at step 108 may be made upon an output device such as a display that presents data to a clinician or other employee of a CDO. The indication may prompt the clinician or employee to retrieve, enter, or correct identified healthcare service data that is required to meet basic protocols. Alternatively, the indication of insufficient healthcare service data at step 108 may induce an output device such as an automated system to retrieve electronic patient medical history data and add this data to the healthcare service data such that the healthcare service data meets the basic protocols. An automated system may be able to identify and locate the needed electronic healthcare service data by the inclusion of identifying symbols, devices, or codes in the protocols. In an embodiment, the symbols, devices, or codes may be LOINC codes needed to identify the proper electronic healthcare service data. After the data has been added to the healthcare service data, the method may begin again to process the newly edited healthcare service data.

If the healthcare service data meets the basic protocols applied in step 106 then one or more protocols may be applied to the healthcare service data to determine if further authorization is required at step 110. In the event that a clinician or an employee submitted an order request 18 as depicted in FIG. 1, the one or more protocols applied to the healthcare service data may identify that additional authorization may be required from the payer before the procedure may be performed, in order that the resulting claim would be reimbursed by the payer. If such an authorization is required, then an authorization indication is generated at step 112 and this authorization indication is displayed in the indication of next work flow step 114. The indication of the next workflow step 114 may be implemented by the use of an output such as a display that displays this indication to a clinician or employee of the CDO, adds the indication to a workflow management list, and/or forwards the healthcare service data to the proper authorizing body if the authorization is required from the payer or its designated reviewer.

If no further authorization is required at step 110, the healthcare service data is further processed at step 116 using one or more protocols to determine if additional content data is required. The one or more protocols applied to the healthcare service data at step 116 may identify healthcare service and/or content data that is required to complete the healthcare service data transaction. If it is determined that no further service or content data is required to supplement the healthcare service data, the healthcare service data may go to the next processing step. The response 118 is indicative of the next action to be taken in processing the healthcare service data. The completion of the processing of the healthcare service data may involve the indication at step 118 that the healthcare service data may be sent to the payer in a transaction. The transmission of the healthcare service data as a transaction would then be identified at the indication of the next workflow step 114, such as processing of a claim or an order transaction.

If it is determined that additional electronic healthcare service or content data is required at step 116, one or more further protocols may be applied to the healthcare service data to determine if the type of the required content data is known. This determination may be made through the use of electronic symbols or devices used for identifying electronic data such as LOINC codes. If the required content data is known to be a particular type of data then an indication of the required content data 124 is made as the indication of the next workflow step 114. The indication may identify an electronic document to be manually or automatically located and attached to a resulting transaction.

If it is identified at step 120 that the type of required content data is not known, a generic indication of the required content data to be retrieved manually may be generated at step 122 and the indication of the type of content data to be retrieved will be indicated at the indication of next workflow step 114. The generic indication of the content data to retrieve generated at step 122 may comprise a display of a description or types of content, such as required documents, to a clinician or employee of the CDO. Upon receiving the indication, the clinician or employee of the CDO may retrieve a paper or electronic copy of the required healthcare service or content data. Alternatively, the indication generated from step 120 may be a yes/no indication of whether the required content data is known. A “no” indication may prompt a clinician to manually identify the required content data.

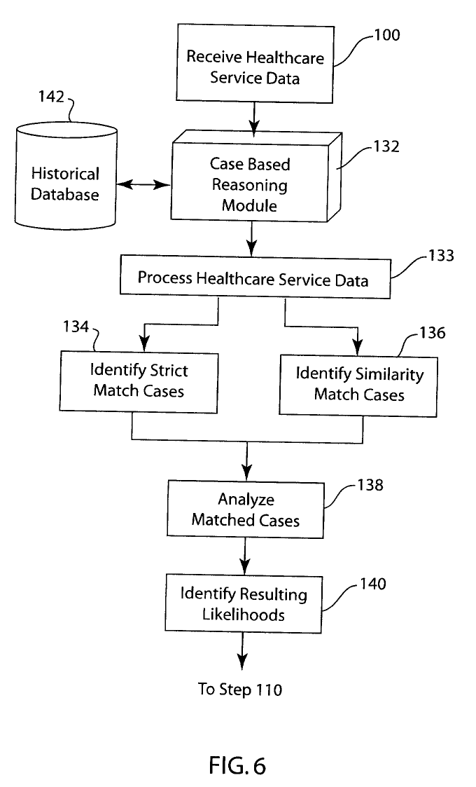

FIG. 6 depicts a detailed depiction of the steps in an embodiment of the method utilizing an on-line case-based reasoning module. In this embodiment of the method, healthcare service data is received at step 100. The healthcare service data received at step 100 may be a subset of a larger amount of healthcare service data to be processed. Next, the healthcare service data received at step 100 is used by a case-based reasoning module 132. It is understood that alternative embodiments of the method may not utilize an implementation of case-based reasoning, but rather may implement a decision tree, a random forest, a neural network, a look-up table, or any other type of mathematical processing of historical data that is suitable for defining one or more protocols.

In the embodiment implementing a case-based reasoning module 132, the case-based reasoning module 132 processes historical data from a historical healthcare service database 142 including claims, requests, responses, additional information or other categories of service data transactions to identify cases with similar healthcare service data as was received in step 100. The case-based reasoning module first identifies strict matched cases in step 134 from the historical healthcare service data. The strict match cases identified in step 134 are cases from the historical healthcare service data that strictly match the healthcare service data received in step 100. Next, the case-based reasoning module 132 identifies similarity matched cases in step 136. The similarity matched cases retrieved in step 136 are cases identified from the historical healthcare service data wherein a substantial similarity exists between the healthcare service data in the historical database and the healthcare service data received in step 100. The similarity matched cases may be selected based upon an indication or a quantification of the similarity between the historical data and the received healthcare service data. In an embodiment, specific sets of healthcare service data may be weighted such that historical cases are retrieved for which there is a likelihood that similar healthcare data may be required for the processing of a claim transaction derived from the receiving healthcare service data.

The matched cases are then analyzed at step 138. The analysis of the matched cases at step 138 may include an identification of the healthcare service data received at step 100 and reviewing the matched cases from steps 134 and 136 to define the likely required format or service or content data that may be required to process the transaction based upon the healthcare service data received at step 100. After the matched cases have been analyzed at step 138 the results from the analysis of the matched cases may be used to identify resulting likelihoods at step 140. These resulting likelihoods may be defined as protocols. The protocols may use a variety of expressions to describe the likelihoods identified in step 140. Therefore, the protocols may utilize fuzzy logic or Boolean logic or other forms of logical expression to codify the likelihood that particular healthcare service or content data may be required. The protocols are then utilized in step 110, 116 and 120 of the flowchart depicted in FIG. 5 to process the healthcare service data received in step 100.

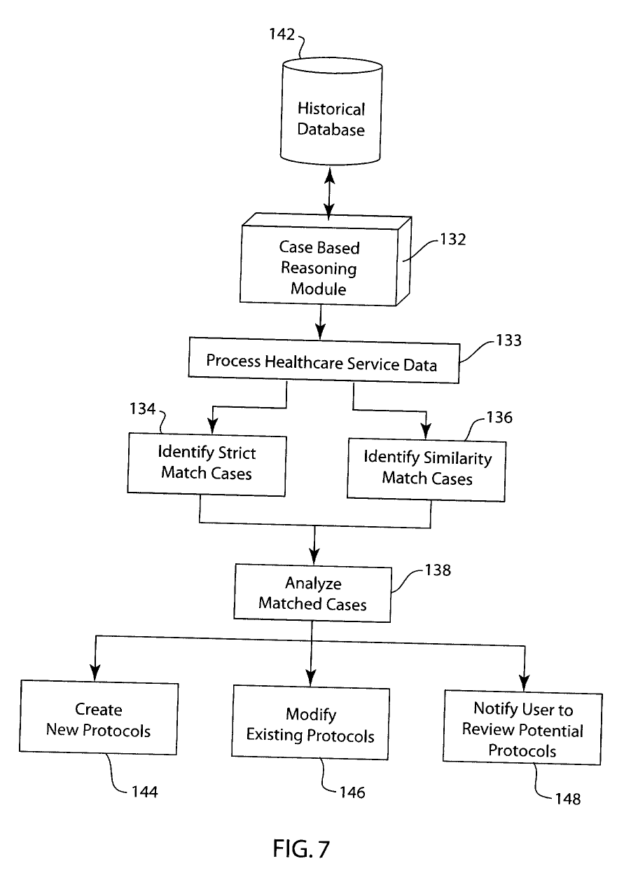

FIG. 7 depicts an embodiment of the method as may be utilized by an off-line implementation of the case-based reasoning module 132. An off-line implementation of the case-based reasoning module 132 may be used to define protocols for later use by processing historical healthcare service data in an off-line situation. This eliminates the need to actively process the historical healthcare service data from a historical healthcare service database each time healthcare service data is to be processed by the system. Furthermore, the offline processing implementation may be utilized at night or on the weekend when it is likely that the servers of a CDO's IT network are experiencing less demand and may therefore be utilized to process the potentially large amounts of historical healthcare service data utilized to produce a new protocol.

In the off-line implementation the case-based reasoning module 132 is connected to one or more historical healthcare service databases 142 such that the case-based reasoning module 132 has access to a variety of healthcare service data. The case-based reasoning module 132 processes the healthcare service data at step 133 to sort the historical healthcare service data in to groupings based on the matching between each of the cases. The case-based reasoning module 132 identify strict match cases at step 134 wherein the healthcare service data indicates that healthcare service data in both of the cases where the same and resulted in the same result. At step 136 similarity matched cases are identified based on a substantial similarity between the healthcare service data of the matched cases.

Next, the matched cases are analyzed at step 138 to identify the relationships between the healthcare service data of the matched cases and the results and/or payer requirements of the cases with the same healthcare service data. The relationships identified in step 138 may be utilized to create new protocols at step 144, modify existing protocols at step 146, or notify a user to review potential new or modified protocols at step 148. In this way, the case-based reasoning module allows the data processing system to learn from historical healthcare service data such that over time the CDOs may process healthcare service data more effectively, resulting in more accurate 837 claim and 278 requests and thereby minimizing 277 requests and 278 responses.

Embodiments of the system and method herein disclosed provide a variety of advantages over the systems and methods previously employed to process healthcare service data to be used in data transactions. Embodiments of the system and method disclosed herein reduce the manual steps required to process healthcare service data for creating 837 claims, 278 requests, and 275 additional information transactions. Furthermore, CDOs benefit from the ability to generate claims that are able to be processed faster by the payer, therefore resulting in the CDOs receiving payment for the services rendered in a more timely fashion. The CDOs also benefit by a reduction in the number of denied claims and received 277 document requests from the payers as the CDOs can submit claims to the payers that are more likely to be complete in the healthcare service and content data required by the payer for a fill adjudication of the claims. CDOs additionally benefit in that an automated system or automated implemented method reduces the time required by clinicians and/or other employees in preparing healthcare service and content data for specific data transactions. The clinician or CDO employee workflow is further made more efficient by reducing the content data attached to each transaction by identifying only the content data that need be attached for the proper adjudication of the transaction. Also, the CDO may benefit by the elimination of costs that are associated with answering 277 document requests and 278 responses by reducing the number of 277 and 278 document responses received and improved efficiency in preparing the 275 additional information transactions. Furthermore, embodiments of the system and/or method as herein disclosed make patient medical procedure scheduling more efficient as any authorization may be obtained for a scheduled procedure in advance to the date the procedure is performed such that the procedure will not have to be rescheduled due to a lack of receiving authorization prior to the procedure date.

Additionally, payers may receive benefits from the implementation of embodiments of the system and method including the ability to adjudicate claims the first time without having to submit a 277 document request back to the CDO because the original claim from the CDO comprises the required healthcare service and content data. Additionally, the electronic processing of healthcare service data by a CDO allows a payer to implement a system for automatic adjudication of the electronic claims wherein the claims include the healthcare service and the additional information content includes the associated LOINC codes. Furthermore, payers see benefits by the implementation of systems and methods as disclosed herein in that the payer only receives the healthcare service and content data that the payer requires for the adjudication of the claim and eliminates the transmission of the unnecessary data.

This written description uses examples to disclose features of the embodiments, including the best mode, and also to enable any person skilled in the art to make and use the invention. The patentable scope is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

Various alternatives and embodiments are contemplated as being with in the scope of the following claims, particularly pointing out and distinctly claiming the subject matter regarded as the invention.

What is claimed is:

1. A method of processing healthcare service data to determine if additional content data is required, the method comprising:
receiving healthcare service data;
receiving at least one protocol from at least one knowledge source comprising at least one protocol derived by automated learning from historical healthcare service data;
applying the at least one protocol to the healthcare service data to determine if additional content data is required to meet the at least one protocol;
generating a response indicative of the content data required to meet the at least one protocol, upon determining that additional content data is required; and
generating a response indicative of the next workflow step, upon determining that no additional content data is required.

2. The method of claim 1 further comprising producing an indication of a next workflow step to be taken in processing the healthcare service data.

3. The method of claim 2 further comprising:
applying at least one protocol to the healthcare service data to determine if the healthcare service data meets basic protocol requirements;
upon determining that the protocol does not meet basic protocol requirements, producing an indication of insufficient healthcare service data.

4. The method of claim 3 further comprising:
applying at least one protocol to the healthcare service data to determine if additional authorization is required; and
upon determining that additional authorization is required, producing an indication indicative of the additional authorization required.

5. The method of claim 4 further comprising:
applying at least one protocol to the healthcare service data to determine if additional content data is required;
providing an indication of the next workflow step if no additional content data is required; and
providing an indication of the required content data if additional content data is required.

6. The method of claim 5 further comprising:
providing an indication of the type of content data that is required if the type of required content data is known; and
providing a generic indication that content data is required if the type of required content data is not known.

7. The method of claim 1 wherein the healthcare service data comprises at least: care delivery organization identification data, service data, and payer identification data.

8. A decision engine for use in conjunction with an automated system including a process manager for processing healthcare service data for a healthcare data transaction, the decision engine comprising:
a knowledge source in communication with at least one database of stored historical healthcare service data, the knowledge source identifying at least one protocol derived by automated learning from historical healthcare service data, the protocol defining a content data requirement for a healthcare data transaction; and
a means for applying at least one protocol to the healthcare service data, the means for applying being in communication with the knowledge source and in communication with the process manager such that healthcare service data is received from the process manager, the means for applying determining any required additional healthcare service or content data and transmitting a response indicative of the required additional content data to the process manager.

9. The decision engine of claim 8 wherein the knowledge source comprises a case-based reasoning module.

10. The decision engine of claim 9 wherein the case-based reasoning module processes the historical healthcare service data to identify matched cases, analyzing the matched cases, and identifying protocols based on the analysis of the matched cases.

11. The decision engine of claim 10 wherein the case-based reasoning module identifies strict match cases and identifies similarity matched cases.

12. The decision engine of claim 10 wherein the case-based reasoning module create new protocols and modifies existing protocols based on the analyzed matched cases.

13. The decision engine of claim 8 wherein the knowledge source identifies at least one protocol using a statistical analysis of the historical healthcare service data.

14. The decision engine of claim 8 wherein the knowledge source codifies at least one protocol using fuzzy logic.

15. The decision engine of claim 8 wherein the knowledge source codifies at least one protocol using a decision tree.

16. The decision engine of claim 8 wherein the at least one protocol identifies the required content data by identifying at least one symbol associated with the content data.

17. The decision engine of claim 16 wherein the symbol associated with the content data is a LOINC code.

18. A healthcare data management system for processing healthcare service data to identify required content data to be sent to a payer, the system comprising:
an input device facilitating the entry of healthcare service data to be used in a healthcare data transaction;
a process manager in communication with the input device, the process manager receiving the healthcare service data;
a knowledge source in communication with at least one database of healthcare service data, the knowledge source identifying at least one protocol by automated learning from the healthcare service data, the protocol defining a content data requirement;
a decision engine in communication with the process manager and in communication with the knowledge source such that the decision engine receives the healthcare service data from the process manager, receives at least one protocol from the knowledge source, applies the at least one protocol to the healthcare service data to produce a response indicative of required content data, and transmits the response to the process manager; and
an output device in communication with the process manager such that the output device receives the response from the process manager and indicates a workflow step to be performed in accordance with the response.

19. The system of claim 18 wherein the knowledge source further comprises a knowledge database, the knowledge database comprising a plurality of protocols.

20. The system of claim 19 wherein the knowledge database comprises protocols defined by at least one payer, at least one care delivery organization, and at least one third party.

21. The system of claim 19 wherein the knowledge source comprises a case-based reasoning module.

22. The system of claim 18 wherein the response indicates a workflow step to be performed.

23. The system of claim 22 wherein the indication of a workflow step comprises the visual display of a manual action to be taken.
